(19) United States
(12) Patent Application Publication
(10) Pub. No.: US 2026/0302115 A1
(43) Pub. Date: Oct. 1, 2026

(54) HIGH-VOLTAGE CONTACTOR OR HIGH-VOLTAGE RELAY

(71) Applicant: PIERBURG GMBH, NEUSS (DE)

(72) Inventors: JURI WAGNER, TITZ (DE); PETER KUESGEN, NEUSS (DE); DANIEL FUHRMANN, REMSCHEID (DE)

(73) Assignee: PIERBURG GMBH, NEUSS (DE)

(21) Appl. No.: 19/490,956

(22) PCT Filed: Aug. 10, 2023
(86) PCT No.: PCT/EP2023/072251

§ 371 Date: Dec. 8, 2025

(51) Int. Cl. H01H 50/36; H01H 50/54

(52) U.S. Cl. CPC H01H 50/36; H01H 50/54

(57) ABSTRACT

A high-voltage contactor or a high-voltage relay includes an electromagnetic actuator, a housing having a contact chamber, permanent magnets, a contact bridge, and a magnetic field conducting body having noses. The actuator has a coil, a movable armature, and an iron circuit surrounding the coil. The iron circuit has a back iron plate. The permanent magnets are arranged diametrically opposite to each other inside the contact chamber. The contact bridge is displaceable within the contact chamber via the actuator into a first position where a first contact element electrically contacts a second contact element via the contact bridge, and into a second position where the contact is interrupted. The magnetic field conducting body magnetically connects the permanent magnets and lies axially against the back iron plate. The back iron plate has recesses which correspond to the noses. One of the noses engages with at least one of the recesses.

### CROSS REFERENCE TO PRIOR APPLICATIONS

This application is a U.S. National Phase application under 35 U.S.C. § 371 of International Application No. PCT/EP2023/072251, filed on Aug. 10, 2023. The International Application was published in German on Feb. 13, 2025 as WO 2025/031601 A1 under PCT Article 21(2).

### FIELD

The present invention relates to a high-voltage contactor or to a high-voltage relay with an electromagnetic actuator with a coil, a movable armature, and an iron circuit surrounding the coil with a back iron plate, a housing with a contact chamber, a contact bridge which is displaceable within the contact chamber by the actuator into a first position in which the first contact element is electrically connected to the second contact element via the contact bridge, and into a second position in which an electrical contact between the first contact element and the second contact element is interrupted, and a magnetic field conducting body which magnetically connects at least two permanent magnets which are arranged diametrically opposite to each other inside the contact chamber, wherein the magnetic field conducting body lies axially against the back iron plate and is provided with a plurality of noses.

### BACKGROUND

Such high-voltage contactors are required to connect and disconnect electrical connections in an electrically load-free or load state, wherein voltages of over 1000 V and currents of over 1000 A can occur in the load state, which can, for example, occur between the traction battery and the drive motor or between a charging station and the traction battery in a battery-powered electric vehicle.

Such a switching device is described, for example, in CN 111091987 A. The magnetic field conducting body of the switching device therein described is defined in two parts and is provided with several axially extending noses with which the magnetic field conducting body lies against the back iron plate. The magnetic field conducting body must therefore be supported in several directions and precisely aligned during assembly so that it can be placed exactly on the back iron plate.

### SUMMARY

An aspect of the present invention is to provide a high-voltage contactor or a high-voltage relay in which the magnetic field conducting body can be positioned and aligned relatively easily during assembly so that no additional holding devices are required when overmolding with plastic.

In an embodiment, the present invention provides a high-voltage contactor or a high-voltage relay which includes an electromagnetic actuator, a housing comprising a contact chamber, at least two permanent magnets, a contact bridge, and a magnetic field conducting body. The electromagnetic actuator comprises a coil, an armature which is configured to be movable, and an iron circuit which is configured to surround the coil. The iron circuit comprises a back iron plate. The at least two permanent magnets are arranged diametrically opposite to each other inside the contact chamber. The contact bridge is arranged to be displaceable within the contact chamber via the electromagnetic actuator into a first position in which a first contact element is in an electrical contact with a second contact element via the contact bridge, and into a second position in which the electrical contact between the first contact element and the second contact element is interrupted. The magnetic field conducting body comprises a plurality of noses. The magnetic field conducting body is configured to magnetically connect the at least two permanent magnets and is arranged to lie axially against the back iron plate. The back iron plate comprises a plurality of recesses. The plurality of recesses correspond to the plurality of noses. A respective one of the plurality of noses is configured to engage with at least one of the plurality of recesses.

### BRIEF DESCRIPTION OF THE DRAWINGS

The present invention is described in greater detail below on the basis of embodiments and of the drawings in which:

FIG. 1 shows a side view of a high-voltage contactor according to the present invention in a sectional view; and

FIG. 2 shows a perspective view of the back iron plate and the magnetic field conducting body of the high-voltage contactor of FIG. 1 in a pre-assembled state.

### DETAILED DESCRIPTION

The high-voltage contactor or high-voltage relay according to the present invention is provided with an electromagnetic actuator via which the contactor can be switched. The term “electromagnetic actuator” refers to all actuators that generate movement based on a force caused by electromagnetism. The electromagnetic actuator comprises a coil consisting of a coil carrier and a winding wound thereon, as well as an armature movable by the electromagnetic force, which is arranged inside the coil, and an iron circuit surrounding the coil, with a back iron plate defining a part of the iron circuit.

For reasons of simplicity, only the term high-voltage contactor will be used below, however, it also refers to a high-voltage relay.

The terms radial, axial, and diametric also refer to the center axis of the high-voltage contactor along which the armature of the actuator is movable.

The high-voltage contactor also comprises a multi-part housing, for example, made of plastic, with an inner contact chamber arranged axially adjacent to the actuator. The housing is defined so that the contact chamber is almost completely sealed against the environment so that merely a slow air exchange and a slight pressure equalization with the environment occurs.

The formation of an arc in the contact chamber rapidly generates a relatively high pressure compared to the environment which cannot immediately be relieved due to the slow exchange of air between the contact chamber and the environment. Although the high pressure enhances arc extinction, it also results in increased strength requirements for the housing.

The high-voltage contactor is further provided with a first and a second contact element which are fixedly attached to the housing, which protrude into the contact chamber, and which are connected outside the high-voltage contactor to two busbars, one of them being connected to the battery and the other being connected, for example, to the drive motor or to a charging station and the vehicle battery. An electrical connection between these two contact elements can be provided by a contact bridge which is moved in the contact chamber by the actuator. By energizing the winding, the contact bridge, at the ends of which two electrical contacts may be defined, is usually moved axially against the two contact elements attached to the housing so as to provide an electrical connection between the first contact element and the second contact element via the contact bridge in a first position. The contact bridge is therefore functionally connected to the armature, for example, via an actuating rod, and is pressed against the contact elements by the movement of the armature or rotor due to the electromagnetic force. To open this electrical connection, the contact bridge is loaded in the opposite direction, which is usually achieved via a spring force acting on the armature or contact bridge in an opposite direction to the electromagnetic force, so that out of the current flow periods, the contact bridge is moved into a second position in which electrical contact between the first contact element and the second contact element is interrupted.

The high-voltage contactor is also provided with a magnetic field conducting body which magnetically connects at least two permanent magnets which are arranged diametrically opposite to each other in the contact chamber. The magnetic field conducting body is therefore in direct contact with the at least two permanent magnets which can, for example, be arranged radially adjacent to the contact location between the first contact element and the first contact plate of the contact bridge or to the contact location between the second contact element and the second contact plate of the contact bridge. The separating of the contact bridge from the contact elements may result in the occurrence of arcs which may damage the high-voltage contactor and, in particular, the contact chamber with its adjacent components. The respective arcs that occur when the contact plates and contact elements are separated can be bent into an arc shape with the magnetic fields of the permanent magnets (which are often called blow magnets) or with the Lorentz force from the magnetic fields, which elongates the arcs and which causes them to extinguish. The permanent magnets are aligned so that the Lorentz force deforms the arcs into an arc shape. The magnetic field conducting body provides a magnetic short circuit between the permanent magnets, which results in a relatively good magnetic field concentration and is particularly advantageous for both the local field strength and the field homogeneity of the magnetic fields generated by the permanent magnets, which is eventually beneficial for extinguishing of the arcs.

The magnetic field conducting body lies axially against the back iron plate and is therefore in a direct magnetically conductive contact with the back iron plate and thus also with the iron circuit of the actuator. The magnetic field conducting body is further provided with several noses. These are protrusions which extend axially from an end wall of the magnetic field conducting body in the direction of the back iron plate and which extend in the circumferential direction along the side wall of the magnetic field conducting body. The noses are thus part of the side wall of the magnetic field conducting body and can, for example, be rectangularly defined, forming two nose side surfaces arranged parallel to each other and aligned parallel to the axis of movement.

According to the present invention, the back iron plate is provided with recesses corresponding to the noses into which the noses engage. The recesses are, for example, openings in the back iron plate which extend axially either partially into the back iron plate or completely through the back iron plate. The recesses can, for example, be defined rectangularly with respect to a cross-sectional plane oriented orthogonally to the axis of movement of the actuator, but may also be provided with any other suitable shape, for example, a circular shape or an oval shape. The inner distance between the two walls of the respective recesses facing each other in the circumferential direction is only slightly greater than the width of the nose in the circumferential direction so that each nose lies with at least one of its nose side surfaces against the corresponding inner wall of the recess assigned thereto. Slightly larger here means that the recess can, for example, be a few tenths of a millimeter larger so that the magnetic field conducting body can be inserted relatively easily into the recess with the noses while the magnetic field conducting body is only movable to a relatively limited extent. A form fit is thereby created between the magnetic field guide body and the back iron plate which prevents both a translational movement of the magnetic field guide body transverse to the axis of movement and a rotational movement around the axis of movement.

The one-sided axial contact of the magnetic field guide body also prevents a translational movement in one of the two axial directions so that in the assembled state only one single degree of freedom exists in the axial direction opposite to the back iron plate. This insert connection allows the magnetic field conducting body to be pre-assembled during the manufacturing process without the use of an additional guide or fastening element, and to be held securely in its final position on the back iron plate during the subsequent manufacturing steps by gravity, which acts against the last remaining degree of freedom. An additional securing element can be provided if necessary, for example, in the form of a hold-down device, a snap hook connection, or a stop device, which also locks the last degree of freedom and completely fixes the magnetic field conductor in its final position. This provides a particularly simple and cost-effective plug connection that significantly simplifies the further manufacturing process compared to the switching device of the prior art which requires additional devices for positioning and fixing the magnetic field conducting body.

In an embodiment of the present invention, the magnetic field conducting body can, for example, completely surround the contact chamber, i.e., the magnetic field conducting body completely encloses the contact chamber radially. The magnetic field conducting body may, for example, be provided with a tubular shape with a rectangular or circular cross-section. The magnetic field conducting body can, for example, be made of a ferromagnetic metal and is therefore provided with a relatively high strength compared to the housing, which is mostly made of plastic. The occurrence of arcing in the contact chamber is followed by a sudden, relatively high pressure increase in the contact chamber, which loads the housing sections surrounding the contact chamber radially and, in the worst case, can cause the housing to burst. Due to the magnetic field conducting body surrounding the contact chamber, a metallic reinforcement of the housing section that radially surrounds the contact chamber is provided which withstands the high pressures in the contact chamber caused by the arcs and therefore protects the housing from damage. The contact chamber walls can, however, be designed to be relatively thin which is particularly advantageous regarding the compactness of the high-voltage contactor.

In an embodiment of the present invention, the magnetic field conducting body can, for example, be provided with a substantially flat contact surface with which the magnetic field conducting body lies axially against the back iron plate, wherein, starting from the contact surface, the noses extend axially into the recesses. The contact surface, which is flat with the exception of the noses, can, for example, be an end surface of the magnetic field conducting body facing in an axial direction, the normal of the end surface being aligned parallel to the axis of movement. The contact surface provides a relatively large contact area between the magnetic field conducting body and the back iron plate, whereby a tilting of the magnetic field conducting body during the manufacturing process is, for example, impeded.

In an embodiment of the present invention, the magnetic field conducting body can, for example, be provided with a total of two noses which are arranged diametrically opposite to each other. The diametrically opposite arrangement of the noses makes it possible to create the necessary form fit for blocking the translational movement transverse to the axis of movement and the rotational movement around the axis of movement with only two noses. This results in a relatively good cost-benefit ratio with regards to the structural design and manufacturing of the high-voltage contactor.

In an embodiment of the present invention, the back iron plate can, for example, be arranged axially between the contact chamber and the actuator. The back iron plate thus forms a metallic separating wall or a metallic reinforcement of a separating wall between the actuator chamber and the contact chamber so that the contact chamber is relatively robust against mechanical stresses which can be caused, for example, by an increase in pressure in the contact chamber, which pressure increase can occur as a result of the formation of arcs when the contact bridge is separated from the contact elements.

In an embodiment of the present invention, the recesses can, for example, be arranged at the rim of the back iron plate and are radially open towards the outside. The recesses are therefore, for example, defined as rectangular pockets that define a part of the outer contour of the back iron plate. The back iron plate can thereby be designed and manufactured relatively easily since the recesses can be produced as part of the outer contour during the manufacturing process in one single manufacturing step. The back iron plate can also be designed relatively compactly in the radial direction, which also results in a compact design of the high-voltage contactor.

In an embodiment of the present invention, each recess can, for example, be defined by two protrusions of the back iron plate, which are arranged adjacent to each other in the circumferential direction and distant from each other, and which extend radially outwards. The protrusions can, for example, extend parallel to each other from the radial outer surface of the back iron plate towards the outside, wherein only the two inner walls of the protrusions facing each other in the circumferential direction, against which the noses rest, need to be arranged parallel to each other. The back iron plate can be designed very compactly due to the design of the back iron plate with the protrusions so that, from a design perspective, a relatively compact high-voltage contactor is provided.

In an embodiment of the present invention, the back iron plate and the magnetic field conducting body can, for example, be overmolded with plastic in the assembled state. The housing of the high-voltage contactor, or at least parts thereof, are manufactured using an injection molding process. It may be advantageous to overmold the back iron plate and the magnetic field conducting body with plastic in a joint injection molding process to create a specifically sealed contact chamber so that a seamless and joint-free enclosure of the contact chamber is created. The insert connection created by the noses engaging into the recesses provides an element for positioning the magnetic field conducting body on the back iron plate and holding it in position during the injection molding process. When the injection point through which the injection mold is filled is placed on that axial side of the magnetic field conductor to which the magnetic field conducting body is displaceable, the magnetic field conducting body can be pressed against the back iron plate by the injection pressure and thus be held safely in position. A hold-down device can alternatively be provided in the injection mold. A metal-reinforced wall is created around the contact chamber via the overmolding, wherein the magnetic field conducting body reinforces the contact chamber wall radially surrounding the contact chamber, and the back iron plate reinforces the contact chamber wall axially bounding the contact chamber in the direction of the actuator. The injection molding process can be simplified significantly by using the insert connection since no additional holding devices for the magnetic field conducting body need be provided. The manufacturing rate can thereby be increased compared to a high-voltage contactor with a non-inserted magnetic field conducting body and the manufacturing costs reduced.

In an embodiment of the present invention, the magnetic field conducting body can, for example, be made of a sheet metal material. The magnetic field conducting body is thus relatively thin-walled, with a sheet thickness of less than 3 mm. This allows the magnetic field conducting body to be manufactured relatively easily in large quantities, for example, by bending or deep drawing, and is therefore particularly suitable for a series-produced high-voltage contactor.

In an embodiment of the present invention, the magnetic field conducting body can, for example, be defined in the form of a rectangular tube and is provided with two long side walls and two short side walls. The contact chamber accordingly also has a rectangular shape. This shape is particularly suitable because the contact bridge is also provided with an elongated, mostly rectangular shape, so that the shape of the contact chamber is adapted to the shape of the contact bridge and the distance between the contact bridge and the radial side walls of the contact chamber is approximately the same on all sides. No more space than is necessary is therefore required for the contact chamber, which in total results in a relatively compact design of the high-voltage contactor.

In an embodiment of the present invention, the magnetic field conducting body can, for example, be made from a flat sheet metal strip by bending. The flat sheet metal strip is bent by 90° at at least three points forming corners so that a rectangular tube is formed, wherein the two ends of the sheet metal strip abut each other in the bent state in the fourth corner. The sheet metal strip can, for example, be provided with four bending locations with 90° bends so that the two ends of the sheet metal strip abut each other in the region of a side wall between the two corners, thereby enabling a smooth connection of the butt joints. Manufacturing by bending is very cost-efficient and therefore especially suitable for series production. A bent magnetic field conducting body is also provided with a constant sheet thickness which would not exist with a deep-drawn magnetic field conducting body for manufacturing reasons.

In an embodiment of the present invention, the magnetic field conducting body can, for example, be provided with a connecting structure via which the ends of the magnetic field conducting body, which abut each other in the bent state, are connected to each other. The connecting structure is defined so that the two ends that abut each other cannot move away from each other in the circumferential direction, thereby preventing the rectangular tube forming the magnetic field conducting body from widening during the manufacturing process, for example, during an injection molding process. This is achieved by a connecting structure that creates a form fit in the circumferential direction, whereas in the direction orthogonal to thereto, which is arranged normal to the sheet metal plane, a simple release of the connection is possible. The two ends of the magnetic field conducting body are defined similarly to puzzle pieces, which are securely connected against relative movements in the sheet metal plane when joined together. One end is therefore provided with a recess which is undercut in the circumferential direction, and the other end is provided with a correspondingly shaped projection which sits in the recess. After being inserted into the recesses during the manufacturing process, the projection can also be widened within the sheet metal plane via a corresponding tool so that the projection sits precisely and without play in the recess. This can, for example, be achieved by inserting a mandrel that is pressed into the center of the projection, thereby displacing the material outwards, whereby it is pressed against the inner walls of the recess and lies against the inner walls in a form-fitting manner. This provides that the noses of the magnetic field conducting body sit securely in the recesses of the back iron plate and that the magnetic field conducting body is thus fixed in its position.

The connecting structure is advantageously provided with at least one dovetail joint. The dovetail joint is one of the possible puzzle-like designs of the connecting structure and is characterized by its excellent form stability in all directions of the sheet metal plane. For further improvement, several dovetail joints can also be arranged along the adjoining ends, which additionally reinforce and stabilize the connecting structure.

The noses can, for example, be defined at the short side walls since the short side walls are stronger and less susceptible to deformation than the long side walls. Arranging the noses on the short side therefore achieves a more secure connection between the magnetic field conducting body and the back iron plate than arranging the noses on the long side.

In an embodiment of the present invention, the magnetic field conducting body can, for example, be provided with several openings that penetrate the magnetic field conducting body radially. The openings fill with plastic during the overmolding of the magnetic field conducting body in an injection molding process for the manufacture of the contact chamber walls, thereby creating an additional form-fitting connection between the magnetic field conducting body and the contact chamber wall enclosing the magnetic field conducting body which holds the magnetic field conducting body securely in its position.

In an embodiment of the present invention, the permanent magnets can, for example, lie against the short side wall of the magnetic field conducting body. This allows the permanent magnets to be brought relatively close to the contact locations, thereby resulting in a relatively high extinguishing effect.

An embodiment of a high-voltage contactor or high-voltage relay according to the present invention is shown in the drawings and is described below.

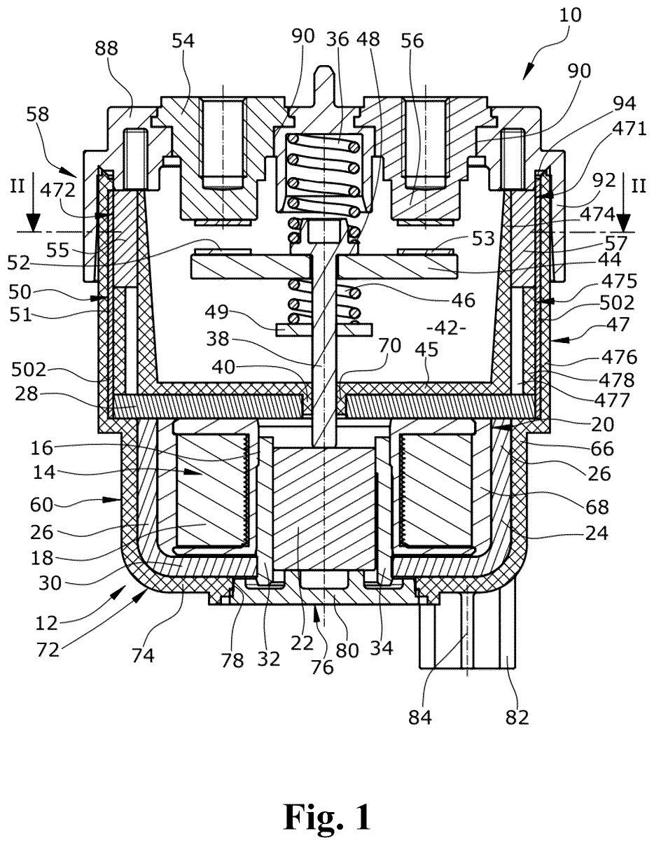

The high-voltage contactor 10 or high-voltage relay shown in FIG. 1 comprises an electromagnetic actuator 12 which is provided with a coil 14 that consists of a coil carrier 16 and a coil winding 18 wound thereon, a ferromagnetic iron circuit 20, and an armature 22. The ferromagnetic iron circuit 20 comprises a yoke 24 which is bent into a U-shape and whose legs 26 lie against a back iron plate 28 or are attached to the back iron plate 28 so as to define a closed ferromagnetic iron circuit 20.

The yoke 24 is provided at its base section 30 with a central opening 32 whose diameter substantially corresponds to the inside diameter of the coil carrier 16. A bushing 34 is fixedly attached in this central opening 32 or at the inside of the coil carrier 16 in which the armature 22 is displaceable arranged and guided. When current flows through the coil 14, the armature 22 is pulled in a well-known manner against the force of a return spring 36 in the contact chamber 42 towards the back iron plate 28.

An actuating rod 38 lies axially against the armature 22 on the contact chamber side and protrudes into a contact chamber 42 through another central opening 40 in the back iron plate 28. A contact bridge 44 is arranged at the end of the actuating rod 38 opposite to the armature 22. The contact bridge 44 can, for example, be pushed against a stop 48 at the end of the actuating rod 38 by a spring element 46 which is supported on a protrusion 49 of the actuating rod 38 and is accordingly arranged on the actuating rod 38 slightly axially moveable and tiltable. A respective contact plate 52, 53 is attached at the ends of the contact bridge 44 which consists of a particularly well-conducting material. The first contact plate 52 is arranged axially opposite to a first contact element 54, which can in particular be connected to a high-voltage battery via a busbar (not shown). The second contact plate 53 is arranged opposite to a second contact element 56 which can, for example, be connected to a drive motor of a motor vehicle via a busbar.

The entire high-voltage contactor 10 is arranged in a housing 58 which is composed of a total of three parts as can in particular be seen in FIG. 1. The actuator 12 is overmolded with plastic to form the housing body 60. This plastic surrounds the coil 14 completely radially to define a radial boundary wall 66 and also fills a space 68 radially between the coil 14 and the yoke 24. The yoke 24 itself is also completely radially encased by this plastic and is thereby shielded against the environment. The back iron plate 28, which lies against the coil carrier 16 at that side which faces the coil carrier, is also covered axially by this plastic in the direction of the contact chamber 42, thereby defining an axial contact chamber wall 45. The central opening 40 of the back iron plate 28 is also covered radially inwards by the plastic, exposing only a central guide opening 70 in which the actuating rod 38 is guided.

On the axial outer side 72 of the housing body 60, which is opposite the contact chamber 42, the plastic extends further radially inwards along a radially outer region 74 of the base section 30 of the yoke 24 or the actuator 12, only exposing an opening 78 in the central, radially inner section 76, which is defined to be symmetrical to the central opening 32 but whose diameter is slightly larger to provide sufficient space for pressing in the bushing 34.

This opening 78 is closed by a plastic cover 80 which is materially bonded to the housing body 60 in the opening 78, in particular by laser welding, ultrasonic welding, or rotational vibration welding.

The housing body 60, which is manufactured by overmolding the actuator 12, furthermore defines a structure in the form of a plug housing 82 through which the connecting lines 84 to the coil winding 18 of the coil 14 are guided to the outside so that the electrical connection of the coil 14 to a voltage source can be provided via a plug counterpart.

A circumferential radial contact chamber wall 47 also extends from the back iron plate 28 in extension of the plastic surrounding the actuator 12, which radially bounds the contact chamber 42 and is also integrally manufactured during the overmolding of the actuator 12 and thus defines four side walls of the contact chamber 42 in the present embodiment.

The radial contact chamber wall 47 is provided in a so-called sandwich-type design. The radial contact chamber wall 47 is formed by an inner contact chamber wall 474 and an outer contact chamber wall 476, which are arranged distanced and parallel to each other. A magnetic field conducting body 50 is arranged between the inner contact chamber wall 474 and the outer contact chamber wall 476 which is formed by a ferromagnetic magnetic field conducting sheet 51 and which completely surrounds the contact chamber 42 radially, wherein the radial contact chamber wall 47 and the inner contact chamber wall 474 as well as the outer contact chamber wall 476 are produced by overmolding the magnetic field conducting sheet 51 with plastic on the inside and outside, respectively. The overmolding is performed in the same process step in which also the actuator 12 is overmolded, whereby the outer contact chamber wall 476 is defined as one single piece with the housing body 60 and the inner contact chamber wall 474 is defined as one single piece with the axial contact chamber wall 45. The inner contact chamber wall 474 and the outer contact chamber wall 476 can, however, be connected to each other in a material-bonded manner at several points, for example, through openings 512 in the long side walls 506 of the magnetic field conducting sheet 51.

The contact chamber 42 is formed cuboid-shaped and is therefore provided with a rectangular cross-section, which is radially bounded by four side walls, each formed by the radial contact chamber wall 47. On the two opposite short sides, the side walls of the radial contact chamber wall 47 each are provided with a cuboid-shaped, inward-projecting pocket 471, 472, which are open on that axial side which is opposite with respect to the actuator 12, wherein a permanent magnet 55, 57 is arranged in each respective pocket 471, 472. Each pocket 471, 472 or each permanent magnet 55, 57 arranged in the pocket 471, 472 is arranged adjacent to one of the contact plates 52, 53 of the contact bridge 44. Each permanent magnet 55, 57 is in this case aligned with respect to its magnetic poles so that the Lorentz force exerted by the magnetic fields of the permanent magnets 55, 57 deforms the arc occurring between the contact plates 52, 53 and the contact elements 54, 56 in an arc-shaped manner and the arcs are thereby extinguished as a result of the resulting elongation and faster cooling.

The magnetic field conducting sheet 51 is, in the region of the pockets 471, 472, not completely overmolded on the inside. Each permanent magnet 55, 57 instead contacts the magnetic field conducting sheet 51 on its respective short inner side, whereby the permanent magnets 55, 57 are magnetically conductively connected to each other. A stop structure 475 is arranged within each pocket 471, 472, each of which is formed by two ribs 477, which are arranged parallel and distanced from each other, and a wall projection 478. The wall projection 478 extends radially inwards from the inside of the magnetic field conducting sheet 51. The ribs 477 each extend radially from the arc shielding wall 41 to the wall projection 478. The permanent magnets 55, 57 are in axial contact with the respective stop structure 475, whereby each permanent magnet 55, 57 is arranged with respect to the axial direction at the height of the contact locations in the contact chamber 42.

The magnetic field conducting sheet 51 also extends axially in the actuator direction up to the back iron plate 28 and contacts the back iron plate 28 so that the magnetic field conducting sheet 51 is in a direct, magnetically conductive contact with the back iron plate 28 and thus with the ferromagnetic iron circuit 20. This results in both an increased local field strength and in an improved homogeneity of the magnetic field, whereby a relatively strong deformation of the arcs and thus a relatively fast extinguishing of the arcs is achieved.

The magnetic field conducting sheet 51 is defined in the form of a rectangular tube and is manufactured from a flat sheet metal strip by bending. The magnetic field conducting sheet 51 is provided with four bending locations 507, which form the corners of the magnetic field conducting sheet 51. At its two ends which abut each other in the bent state, the magnetic field conducting sheet 51 is provided with a puzzle-like connecting structure 510, formed by two axially adjacent and spaced apart dovetail joints 511, which prevent the abutting ends of the magnetic field conducting sheet 51 from moving away from each other in the circumferential direction and the magnetic field conducting sheet 51 from widening radially.

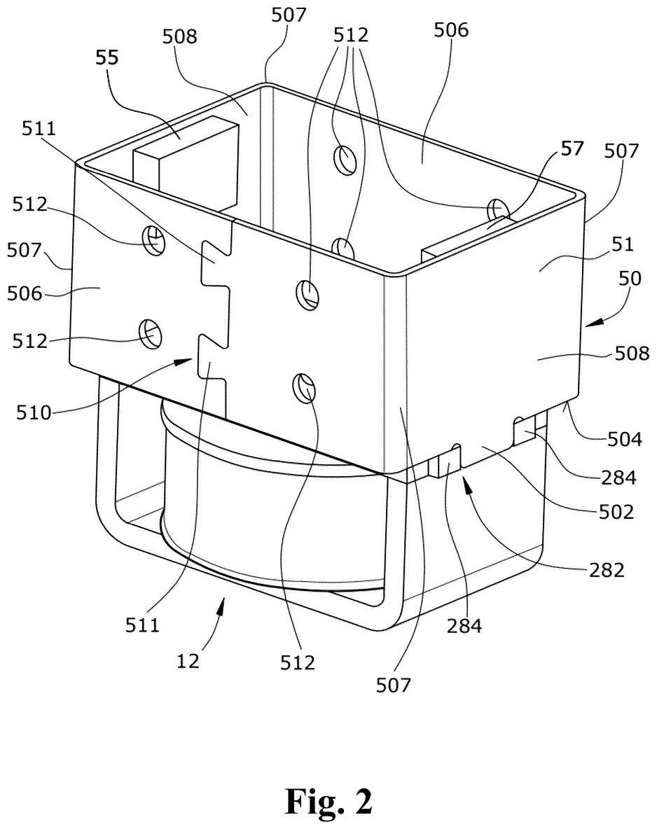

FIG. 2 shows that on its two short side walls 508, the magnetic field conducting sheet 51 is provided with two diametrically opposite noses 502 which extend axially from the contact surface 504 towards the back iron plate 28. Two recesses 282 are arranged at the rim of the rear closure plate 28 into which the noses 502 extend and into which the noses 502 engage. Each recess 282 is formed by two protrusions 284 which are arranged distanced from each other along the circumference of the back iron plate 28 and extending radially outwards parallel to each other. The distance between the two facing inner walls of the adjacent projections 284 is 0.5 mm greater than the width of the noses 502 in the circumferential direction so that the noses 502 are received in the recesses 282 with a relatively small clearance. The recesses 282 are defined to be radially open towards the outside so that the back iron plate 28 is relatively compact in design. The noses 502 prevent a translational movement of the magnetic field conducting sheet 51 in all directions transverse to the axis of movement of the actuator 12 and in the direction of rotation around the axis of movement of the actuator 12. The contact surface 504, which lies axially against the back iron plate 28, also prevents an axial displacement of the magnetic field conducting sheet 51 in the direction of the actuator 12. The magnetic field conducting sheet 51 and the actuator 52 are hereby held in their position during the joint overmolding without any additional holding devices.

The contact chamber 42 in FIG. 1 is, on the axial side opposite to the axial contact chamber wall 45, axially closed by a contact chamber cover 88, which also axially closes the pockets 471, 472. Two axial openings 90 are defined in the contact chamber cover 88, in which the two contact elements 54, 56 are housed and attached, for example, by ultrasonic welding or overmolding. A collar 92 extends circumferentially in the axial direction from this contact chamber cover 88, radially enclosing the circumferential outer contact chamber wall 476, so that the two walls 92, 476 can be connected to each other in a material-bonded manner, for example, by laser welding, ultrasonic welding or rotational vibration welding, thereby creating a high-strength housing 58. A circumferential axial groove 94 is defined directly inside the collar 92, which is thus bounded on the outside by the collar 92 of the contact chamber cover 88 and into which the end of the housing wall 86 of the housing body 60 protrudes, whereby the end is precisely fixed in its position relative to the contact chamber cover 88 before the laser welding, ultrasonic welding, or rotary vibration welding.

If the current flow between the traction electric motor or the charging station and the traction battery is to be allowed, the coil 14 is energized, causing the armature 22 to be pulled towards the back iron plate 28 due to the acting electromagnetic forces. This pushes the actuating rod 38 with the contact bridge 44 and the contact plates 52, 53 against the contact elements 54, 56 so that, via the contact bridge 44, an electric current can flow from the first contact element 54 to the second contact element 56 and thus from the battery to the electric motor or from the charging station to the battery. If the coil 14 is not energized, the actuating rod 38 and the armature 22 are biased by the spring force of the return spring 36 in the opposite direction so that the contact bridge 44 is lifted off the contact elements 54, 56 and the electric circuit is interrupted. This creates an electric arc due to the high currents, which also causes an increase in pressure in the contact chamber 42.

This pressure increase can be easily handled by the housing 58 due to the metal-reinforced walls 45, 47 surrounding the contact chamber 42, while the actuator 12 is also reliably protected, in particular by the molded axial contact chamber wall 45. The leak-proof welding of the only three housing parts also provides complete external leak proofness so that no gas can escape from the contact chamber 42, the arc is extinguished reliably and quickly, and no gases or liquids can penetrate from the outside. The required packaging space and assembly costs are very low.

It should be clear that various modifications are possible in comparison to the described embodiment. The structure of the contact unit and the arrangement of the springs and actuator rod guide and fastening may in particular differ from the embodiment shown.

The present invention is not limited to embodiments described herein; reference should be had to the appended claims.

### LIST OF REFERENCE NUMERALS

10 High-voltage contactor
12 Actuator
14 Coil
16 Coil carrier
18 Coil winding
20 Ferromagnetic iron circuit
22 Armature
24 Yoke
26 Leg
28 Back iron plate
30 Base section
32 Central opening
34 Bushing
36 Return spring
38 Actuating rod
40 Central opening
42 Contact chamber
44 Contract bridge
45 Axial contact chamber wall
46 Spring element
47 Radial contact chamber wall
48 Stop
49 Protrusion
50 Magnetic field conducting body
51 Magnetic field conducting sheet
52 First contact plate
53 Second contact plate
54 First contact element
55 Permanent magnet
56 Second contact element
57 Permanent magnet
58 Housing
60 Housing body
66 Radial boundary wall
68 Space
70 Central guide opening
72 Axial outer side
74 Radially outer region
76 Radially inner section
78 Opening
80 Plastic cover
82 Plug housing
84 Connecting line
88 Contact chamber cover
90 Axial opening
92 Collar
94 Axial groove
282 Recess
284 Protrusion
471 Pocket
472 Pocket
474 Inner contact chamber wall
475 Stop structure
476 Outer contact chamber wall
477 Rib
478 Wall projection
502 Nose
504 Contact surface
506 Long side wall
507 Bending location
508 Short side wall
510 Connecting structure
511 Dovetail joint
512 Opening

What is claimed is:

1-17. (canceled)

18. A high-voltage contactor or a high-voltage relay comprising:
an electromagnetic actuator comprising a coil, an armature which is configured to be movable, and an iron circuit which is configured to surround the coil, the iron circuit comprising a back iron plate;
a housing comprising a contact chamber;
at least two permanent magnets which are arranged diametrically opposite to each other inside the contact chamber;
a contact bridge which is arranged to be displaceable within the contact chamber via the electromagnetic actuator into a first position in which a first contact element is in an electrical contact with a second contact element via the contact bridge, and into a second position in which the electrical contact between the first contact element and the second contact element is interrupted; and
a magnetic field conducting body comprising a plurality of noses, the magnetic field conducting body being configured to magnetically connect the at least two permanent magnets and being arranged to lie axially against the back iron plate,
wherein,
the back iron plate comprises a plurality of recesses,
the plurality of recesses correspond to the plurality of noses, and
a respective one of the plurality of noses is configured to engage with at least one of the plurality of recesses.

19. The high-voltage contactor or the high-voltage relay as recited in claim 18, wherein the magnetic field conducting body is further arranged to radially surround the contact chamber circumferentially.

20. The high-voltage contactor or the high-voltage relay as recited in claim 18, wherein,
the magnetic field conducting body further comprises a contact surface,
the magnetic field conducting body lies axially against the back iron plate via the contact surface, and
the respective one of the plurality of noses extend from the contact surface in an axial direction to engage with the at least one of the plurality of recesses.

21. The high-voltage contactor or the high-voltage relay as recited in claim 18, wherein,
the plurality of noses of the magnetic field conducting body are provided as two noses, and
the two noses are arranged diametrically opposite to each other.

22. The high-voltage contactor or the high-voltage relay as recited in claim 18, wherein the back iron plate is arranged axially between the contact chamber and the electromagnetic actuator.

23. The high-voltage contactor or the high-voltage relay as recited in claim 18, wherein each of the plurality of recesses are arranged at a rim of the back iron plate and to be radially open towards an outside thereof.

24. The high-voltage contactor or the high-voltage relay as recited in claim 23, wherein,
the respective one of the plurality of recesses is arranged between two protrusions of the plurality of protrusions of the back iron plate, and
the two protrusions of the plurality of protrusions are arranged adjacent to each other in a circumferential direction, distant from each other, and to extend radially outwards.

25. The high-voltage contactor or the high-voltage relay as recited in claim 18, wherein the back iron plate and the magnetic field conducting body are each overmolded with a plastic in an assembled state.

26. The high-voltage contactor or the high-voltage relay as recited in claim 18, wherein the magnetic field conducting body is made of a sheet metal material.

27. The high-voltage contactor or the high-voltage relay as recited in claim 26, wherein the magnetic field conducting body is provided in a shape of a rectangular tube and comprises two long side walls and two short side walls.

28. The high-voltage contactor or the high-voltage relay as recited in claim 27, wherein at least one of the plurality of noses is arranged at each one of the two short side walls.

29. The high-voltage contactor or the high-voltage relay as recited in claim 27, wherein the magnetic field conducting body further comprises a plurality of openings which are arranged to penetrate the magnetic field conducting body radially.

30. The high-voltage contactor or the high-voltage relay as recited in claim 29, wherein the plurality of openings are further arranged on each of the two long side walls.

31. The high-voltage contactor or the high-voltage relay as recited in claim 27, wherein a respective one of the at least two permanent magnets is further arranged to contact one of the two short side walls.

32. The high-voltage contactor or the high-voltage relay as recited in claim 26, wherein,
the sheet metal material is a flat sheet metal strip, and
the magnetic field conducting body is manufactured from the flat sheet metal strip by bending.

33. The high-voltage contactor or the high-voltage relay as recited in claim 32, wherein the magnetic field conducting body further comprises a connecting structure via which ends of the magnetic field conducting body, which abut each other in a bent state, are connected to each other.

34. The high-voltage contactor or the high-voltage relay as recited in claim 33, wherein the connecting structure comprises at least one dovetail joint.
